(19) United States
(12) Patent Application Publication
(10) Pub. No.: US 2017/0169576 A1
(43) Pub. Date: Jun. 15, 2017

(54) CROWD INTELLIGENCE ON FLOW VELOCITY MEASUREMENT

(71) Applicant: National Taiwan University, Taipei (TW)

(72) Inventors: Yao-Yu Yang, Taipei (TW); Shih-Chung Kang, Taipei (TW)

(73) Assignee: National Taiwan University, Taipei (TW)

(21) Appl. No.: 15/374,913

(22) Filed: Dec. 9, 2016

Related U.S. Application Data
(60) Provisional application No. 62/265,284, filed on Dec. 9, 2015.

(51) Int. Cl. G06T 7/292; G01F 1/00; G06T 5/00

(52) U.S. Cl. CPC G06T 7/292; G06T 5/002; G01F 1/00

(57) ABSTRACT

The present invention relates to a flow velocity measuring method. The flow velocity measuring method includes providing a video recording a temporal and spatial variation of a flow wherein the video contains multiple frames; selecting multiple sampled frames from the multiple raw frames by a sampling rate and dividing each multiple sampled frames into multiple sub-frames; grouping the multiple sub-frames situated on the same corresponding position on the each multiple sampled frames together to make multiple sub-frame videos; providing each multiple sub-frame videos to different multiple observers, each of which observers marks out a flowing feature for at least one of the multiple sub-frame videos; computing multiple spatial displacements for each multiple flowing features and a time interval between each multiple sampled frames from the sampling rate; and determining a flow velocity of the flow based on all the multiple spatial displacements and the time interval.

This application claims benefit of U.S. Provisional Patent Application No. 62/265,284, filed on Dec. 9, 2015, in the United State Patent and Trademark Office, the disclosure of which is incorporated herein its entirety by reference.

### FIELD

The present invention relates to a flow velocity measuring method, in particular, to a flow velocity measuring method based on multiple observations from the human intelligence and the human visual recognition system.

### BACKGROUND

The flow velocity measurement is important for the hydrology survey and disaster prevention. By acquiring the flow velocity distribution, the flow rate is then able to be computed by the volume flow rate equation. In addition, Lin et al. estimated the flow rate by surface flow velocity. Typically most researchers estimate the strength and the recurrence period of the flood by flow rates. A common way to estimate the flow rate is to use the rating curve for a river. Surveyors measure the flow velocity distribution of the river in different water elevations, calculate the flow rate, and then draw the relation table of flow rate and water elevation. A graph of the relation is called the rating curve. By measuring water elevation, the flow rate is simply available through reviewing the rating curve. Thus, the flow velocity measurement is an important task for hydrology survey and disaster prevention.

There are various schemes to measure the flow velocity. Usually flow velocity measurements are classified into two types: the contact-type measurement and the non-contact-type measurement. The contact-type measurement includes mechanical methods, electromagnetic methods and acoustic Doppler current profiler, etc.

For the contact-type measurement, it is required to be robust and controllable in the flood. The human-intervene operation is needed while executing the contact-type measurement. The contact-type measurements are rarely used in a flood event because they are time-consuming and labor-intensive. In contrast, the non-contact-type measurements make the surveyors safer during a flood event.

For the non-contact-type measurement, the common non-contact-type measurements are usually performed by continuous wave radar meter, by pulsed wave radar meter or by image-based method. The pulsed-wave radar meter emits high power radar wave to measure the flow velocity which the effective detectable radius is in a range from 20 to 2,000 meters. The pulsed radar needs complex human operations and well-experienced operators to filter out the noises. The continuous-wave radar meter is a portable and one-point measuring device. Due to its complex and high accurate mechanism, it is not friendly for users to maintain.

The image-based method is called image velocimetry as well when measuring the flow velocity. The image velocimetry has strong potentials for its application flexibility and technical evolution. The famous Particle Image Velocimetry (PIV) scheme is the most commonly used image velocimetry. The following reviews on the PIV scheme are divided into two groups: the laboratory methods and the on-site methods. Then the PIV algorithm is described later.

Image velocimetry was developed in a controlled environment laboratory and called PIV scheme. The PIV scheme is developed since 1991 which applied two laser sheets emitting on the flow with a delay time, and simultaneous cameras to measure the particles' flow velocity vectors. In 1990's, the PIV related techniques used for flow velocity measurement in many fields and Grant wrote a review paper summarizing them. While the spurious vectors and bias errors commonly occur in PIV results, Hart provided an error correction method by improving spatial resolution and vector yields. After that, using the different types of tracers or the different conditions of hydraulic models are discussed in some research. These methods are implemented in the laboratory and they are the foundations of the on-site methods.

The on-site methods focus on case studies, computation efficiency, noise-reducing and device mobility. Some research used only a camera and developed algorithms to achieve their goals. Large-scale PIV (LSPIV) is a flow velocity on-site measurement which Fujita et. al. discussed three applications of it covering area from 4 to 45,000 square meters in their research in 1998. After 1998, some research implemented LSPIV for estimating the flow on the river. Some of them measured for large rivers, while some measured for small rivers or lakes. However, LSPIV still has the difficulties to overcome. One is that the environmental uncertainties such as the natural light and the weather cause noises on images. The other is the high computation time for PIV analysis. For the problem of high computation time, one research developed space-time image velocimetry assuming the known flow velocity direction which improves computation efficiency but lacks for the information of flow direction.

Moreover, some used the camera integrating with different devices to improve the performance. Fujita et al. used LSPIV to analyze seeded and unseeded flow videos from a helicopter. The insufficient recording time and resolution are the problems for the videos taken by the helicopter. Hauet et al. got the flow images from the web server connected to the camera on site and calculated the flow velocity. They set up the observation system on the Iowa river and pointed out the challenges when using image methods. Kim et al. installed the LSPIV system on a van to enhance the mobility and called it mobile PIV. Fujita et al. installed the high density camera on the helicopter and called it aerial LSPIV. Tsubaki et al. captured the images of the flow from a CCTV, which is commonly used in observation stations of the rivers, and calculated flow velocity by PIV. To eliminate the noises from the natural light, Li et al. took the images by the multi-channel CCD cameras. Zhang et al. enhanced the patterns on the river surface by near infrared radiation (NIR) filter, and Wang et. al. also used NIR on the balloon taking the images under extreme conditions.

The PIV compares the neighboring frames in the video clips, identifies the similar image features and calculates the velocity of the flow. PIV uses a detecting window called interrogation area (IA) to capture the neighboring frames at the same position on the image. Some features are needed on the frames for measuring the flow velocity. PIV calculates the coefficient of cross-correlation between two IA, and then the map of coefficient is generated. The position of the peak on the map is the direction of feature motion which indicates the flow velocity.

However, when the PIV scheme is used to measure the flow velocity on two rivers, there are several deficiencies are found out. The most significant defect is the PIV cannot be used on site for two reasons. First, the parameters such as the size of IA and the size of the step are difficult to be determined. Second, the result is hard to be identified when measured velocity on the flow direction varied significantly.

There is a need to solve the above deficiencies/issues.

### SUMMARY

In order to improve the above deficiencies, we watched the flow videos and assumed that the velocity of the feature on the flow indicates the flow velocity. We found out the reason why the result of PIV varied a lot. The reason is that the significant features are randomly shaped, randomly occurred, and scattering. PIV is unable to filter out those features. The results of PIV would vary a lot if the insignificant features are the major particles in an image.

However, it is found out people are able to easily find out the significant features in a video. People use their pre-attentive process in their visual system to filter and notice the important features. So, it is inspired to take advantage of human intelligence, in particular, the human visual recognition and identification capability. By integrated the human visual system into the flow velocity measuring process to improve the measurements for the flow velocity better and more accurate. Moreover, the numbers of image data is too large to measure for a person, so that it needs a plurality of people, a crowd, to measure the flow velocity together.

The present invention proposes a flow velocity measuring method. The method includes providing a video recording a temporal and spatial variation of a flow wherein the video contains multiple frames; selecting multiple sampled frames from the multiple raw frames by a sampling rate and dividing each multiple sampled frames into multiple sub-frames; grouping the multiple sub-frames situated on the same corresponding position on the each multiple sampled frames together to make multiple sub-frame videos; providing each multiple sub-frame videos to different multiple observers, each of which observers marks out a flowing feature for at least one of the multiple sub-frame videos; computing multiple spatial displacements for each multiple flowing features and a time interval between each multiple sampled frames from the sampling rate; and determining a flow velocity of the flow based on all the multiple spatial displacements and the time interval.

Preferably, the method further includes one of the following steps: determining the sampling rate so as to select the multiple sampled frames from the multiple raw frames; and determining the time interval between each multiple sampled frames based on the sampling rate.

Preferably, the method further includes determining the sampling rate so as to select at least two sampled frames from the multiple raw frames.

Preferably, the method further includes one of the following steps: performing a geometric correction to at least one of the multiple sampled frames so as to obtain a corrected dimension therefor; and implementing a direct linear transform to perform the geometric correction.

Preferably, the method further includes one of the following steps: performing an image enhancement to the multiple corrected sampled frames so as to enhance the multiple flowing features contained in each multiple corrected sampled frames; and implementing an Euler image magnification to perform the image enhancement.

Preferably, the method further includes dividing each multiple sampled frames into multiple sub-frames by a multiple-intersecting parallels dividing scheme.

Preferably, the method further includes one of the following steps: evaluating a confidence level for whether the multiple flowing features on different multiple sub-frames belong to the same flowing behavior based on a degree of variation for the multiple flowing features; weighting each multiple flowing features based on the evaluated confidence level; and computing multiple weighted spatial displacements for each multiple weighted flowing features and determining a flow velocity of the flow based on the multiple weighted spatial displacements.

Preferably, the method further includes one of the following steps: providing a displaying interface for displaying the video and the multiple sub-frame videos for the observers, wherein the displaying interface is designed to show the observers the guiding instructions for selecting the multiple sampled frames from the multiple raw frames and for determining the frame rate and the sampling rate; providing a measuring interface for the observers to operate to mark out multiple flowing features on each multiple sub-frames; and providing an evaluating interface for the observers to operate to evaluate the confidence level.

### DESCRIPTION OF THE DRAWINGS

The patent or application file contains at least one drawing executed in color. Copies of this patent or patent application publication with color drawing(s) will be provided by the Office upon request and payment of the necessary fee. A more complete appreciation of the invention and many of the attendant advantages thereof are readily obtained as the same become better understood by reference to the following detailed description when considered in connection with the accompanying drawing, wherein:

FIG. 1(a) is an image showing the uncorrected image in accordance with the present invention.

FIG. 1(b) is an image showing the corrected image in accordance with the present invention.

FIG. 2(a) is an image showing the sampled image corrected by the orthogonal rectification scheme in accordance with the present invention.

FIG. 2(b) is an image showing the sampled image enhanced by the spatial and temporal filter in accordance with the present invention.

FIG. 2(c) is an image showing the sampled image processed by the Eulerian video magnification in accordance with the present invention.

FIG. 3 is the interface FlowScope showing the sampled image which is divided by multiple intersecting parallels scheme in accordance with the present invention.

FIG. 4 is the interface FlowScope playing the sampled sub-video collecting multiple sub-frames situated on the same corresponding position on the each multiple sampled frames in accordance with the present invention.

FIG. 5(a) is the icons representing three different confidence levels shown in the interface FlowScope in accordance with the present invention.

FIG. 5(b) is the form check window showing the flow features for a specific sub-video evaluated and filled out by the observer responsible for the specific sub-video used in the interface FlowScope in accordance with the present invention.

FIGS. 6(a), 6(b), 6(c) show the process to identify and mark the flow features including the flow direction, the flow position and the flow velocity by operating the measuring module in the interface FlowScope in accordance with the present invention.

FIG. 7 is a schematic diagram illustrating the calculation process for the crowd-based velocimetry in accordance with the present invention.

FIG. 8 is a schematic diagram illustrating the basic concept to divide a sampled frame into multiple sub-frames and to collect multiple sub-frames situated on the same corresponding position on the each multiple sampled frames together to form a sampled sub-video in accordance with the present invention.

FIG. 9 is a schematic diagram illustrating the on-site field configuration for the flow velocity measuring method based on multiple observations in accordance with the present invention.

FIG. 10 shows a flow chart for implementing the flow velocity measuring method based on multiple observations in accordance with the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “comprising” or “including”, used in the claims and specification, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

### First Embodiment

The present invention proposes a novel method to estimate the flow velocity called as a crowd-based velocimetry (CBV) method to incorporate the human intelligence the human perception capacity in the estimation process of the flow velocity. CBV includes three main steps: (1) video preprocessing, (2) feature tracking by the crowd, (3) velocity calculation.

The pre-processing step is to generate the specific sequential sub images of the flow for the measurement in the next step. It consists of geometry correction, image enhancement, and the segmentation method called Video-Temporal-Spatial Segmentation (VTSS) we developed for segmenting the flow video. For the second step, we developed a user interface called as FlowScope to allow the crowd to specify similar features in neighboring images. The crowd need also express their confidence when identifying the features using the custom-made interface FlowScope. Finally, in the third step, a velocity equation is to calculate the feature velocity on the image. After integrating the data from the crowd in difference confidence, we developed a Mode of Confidence Weighting function to calculate the flow velocity.

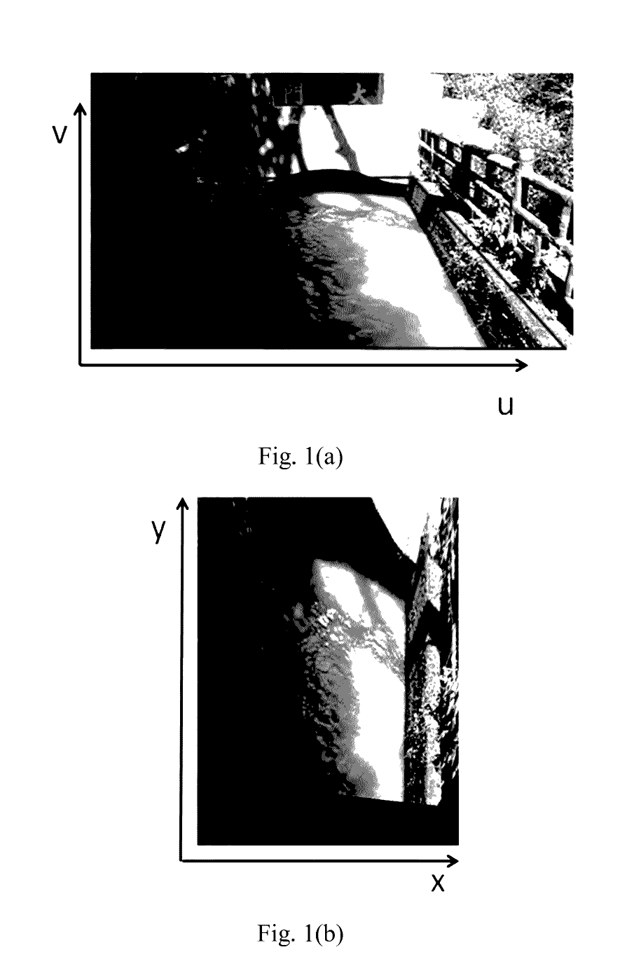

To measure the real distance between two objects on the image, the orthogonal rectification is a process to get the correct dimension of the distance, as shown in FIG. 1(a). The images are transformed by the matrix calculated by direct linear transformation (DLT). The DLT is a common geometry correction method. At least six ground reference points are needed for determining eleven coefficients in the general DLT equation for 3D description, as shown in FIG. 1(b). The 3D general DLT equation are shown as follows:

$$\begin{matrix}u = \frac{{L}_{1} x + {L}_{2} y + {L}_{3} z + {L}_{4}}{{L}_{9} x + {L}_{10} y + {L}_{11} z + 1} & ( 1 ) \\ v = \frac{{L}_{5} x + {L}_{6} y + {L}_{7} z + {L}_{8}}{{L}_{9} x + {L}_{10} y + {L}_{11} z + 1} & ( 2 )\end{matrix}$$

Where u and v are the position in pixel of the ground reference point in an image; x, y and z are the on-site position, L₁ to L₁₁ are the DLT coefficients.

We reduced the dimension of DLT equation from 3D to 2D, so that the minimum number of ground reference points changed from six to four. In addition, the corresponding points of the ground reference points on the image should be located. Considering the dimensional reduction, the number of the coefficients is reduced to eight, and the dimension z is neglected. The above 3D general DLT equations are simplified as follows:

$$\begin{matrix}u = \frac{{L}_{1} x + {L}_{2} y + {L}_{3}}{{L}_{7} x + {L}_{8} y + 1} & ( 3 ) \\ v = \frac{{L}_{4} x + {L}_{5} y + {L}_{6}}{{L}_{7} x + {L}_{8} y + 1} & ( 4 )\end{matrix}$$

Where u and v are the position in pixel of the ground reference point in an image; x, y are the on-site position, L₁ to L₈ are the DLT coefficients.

By solving the above linear equations, the DLT coefficients will be obtained.

$$[ \begin{matrix}x & y & 1 & 0 & 0 & 0 & - ux & - uy \\ 0 & 0 & 0 & x & y & 1 & - vx & - vy\end{matrix} ] [ \begin{matrix}{L}_{1} \\ ⋮ \\ ⋮ \\ ⋮ \\ {L}_{8}\end{matrix} ] = [ \begin{matrix}u \\ v\end{matrix} ] \qquad ( 5 )$$

The on-site position x, y can be then obtained after DLT coefficients L₁ to L₈ and the ground reference point u and v are obtained.

$$\begin{matrix}[ \begin{matrix}{L}_{1} - {uL}_{7} & {L}_{2} - {uL}_{8} \\ {L}_{4} - {vL}_{7} & {L}_{5} - {vL}_{8}\end{matrix} ] [ \begin{matrix}x \\ y\end{matrix} ] = [ \begin{matrix}{L}_{3} - u \\ {L}_{6} - v\end{matrix} ] & ( 6 ) \\ AX = b & ( 7 ) \\ X = {A}^{- 1} b & ( 8 )\end{matrix}$$

To observe subtle changes in a video of a river flow is a challenge for a velocity measurement, so that an enhancement is needed during the measurement. The enhancement we used is Eulerian Video Magnification (EVM). The EVM is used for enhancing the features of the surface flow on the image frames. The EVM method was constructed by a spatial filter and a temporal filter, and can be simply explained by using a 1D signal instead of a 2D signal. The following describes the algorithm of EVM.

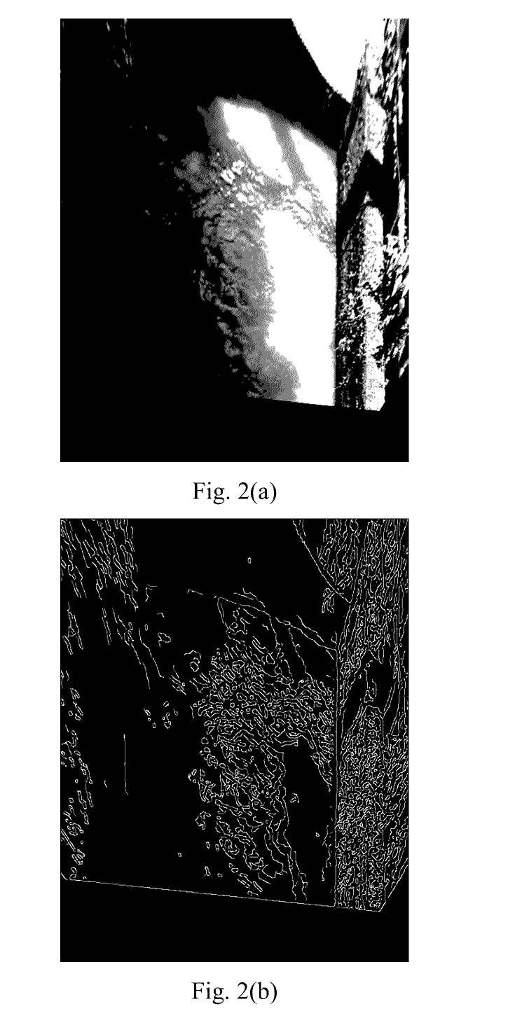

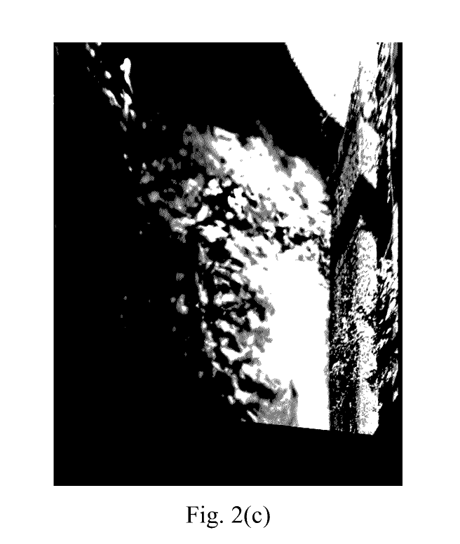

The above-mentioned required schemes for performing the image correction process are as shown in FIG. 2(a) through FIG. 2(c). FIG. 2(a) shows the sampled image corrected by the orthogonal rectification scheme in accordance with the present invention, FIG. 2(b) shows the sampled image enhanced by the spatial and temporal filter in accordance with the present invention, and FIG. 2(c) shows the sampled image processed by the Eulerian video magnification in accordance with the present invention.

Assuming I(x, t) is the image intensity f(x) on a certain position x and at time t. It relates to f(x) which is the function of intensity with a displacement function δ(t).

I(x, t)=f(x+δ(t))amd I(x, 0)=f(x) (9)

Wherein δ(t)=0 at time t=0.

Assuming that a first-order Taylor series expansion can be used to approximate the value of the image intensity f(x), the image intensity function I(x, t) is rewritten into equation (10) as follows:

$$I ( x , t ) \approx f ( x ) + δ ( t ) \frac{\partial f ( x )}{\partial x} \qquad ( 10 )$$

The term

$$δ ( t ) \frac{\partial f ( x )}{\partial x}$$

in equation (10) is a temporal band-pass filter that is B(x, t) which represents the specified changes on images, and the term

$$\frac{\partial f ( x )}{\partial x}$$

is a spatial filter which separates images by a range of a spatial frequency.

$$B ( x , t ) = δ ( t ) \frac{\partial f ( x )}{\partial x} \qquad ( 11 )$$

In order to enhance images, the term B(x, t) is multiplied by α, and add it to the original frame.

Ĩ(x, t)=I(x, t)+αB(x, t) (12)

By combining equations (10), (11) and (12), the equation (13) is generated as follows:

$$\tilde{I} ( x , t ) \approx f ( x ) + ( 1 + α ) δ ( t ) \frac{\partial f ( x )}{\partial x} \qquad ( 13 )$$

The processed output is showed in equation (14).

Ĩ(x, t)≈f(x+(1+α)δ(t)) (14)

In a crowd-based measurement, we need to segment the video clips into still images on spatial and time domain. To evaluate the size of the images, and the number of the images and required data, we provide the solution for evaluating the specific parameters of the measurement. The parameters are classified into three parts: the control parameters which are determined by the on-site environment or the setting of the camera, the independent parameters which are controlled by users, and the dependent parameters which are the results of the evaluation and the input parameters of the image generation.

The control parameters: V_{H}, V_{L}, Fps, W and H, where V_{H} and V_{L} are the maximum and the minimum predicted velocity of the surface flow, Fps is the sampling rate of the camera, W and H are the width and the height of the image after geometry correction.

The independent parameters: W_{sub}, H_{sub}, Fr, Nt, Frₛₚₐₙ and N_{sub-data}, where W_{sub} and H_{sub} are the width and height of the sub-images, Fr is the number of total frames of the sampling video, Nt is the number of sections in the video, Frₛₚₐₙ is the number of frames between selected frames, N_{sub-data} is the total number of data in a sub image.

The dependent parameters: W_{sub,min}, H_{sub,min}, N_{sub}, Fr_{section}, N_{total image} and N_{data}, where W_{sub,min} and H_{sub,min} are the minimum width and height of the sub-images, N_{sub} is the number of sub images in a frame, Fr_{section} is the number of selected frames that are in one time section, N_{total image} is the number of total images used in a measurement, N_{data} is the total number of data which obtained from the measurement.

The equation (15) determines the minimum size of a sub image. It depends on the highest velocity of the flow that the feature of the flow should be recognized in the adjacent frames. The denominator, 2, in the equation (15), means that the maximum displacement of the feature between two adjacent frames is half of the minimum length of the sub image.

$$\begin{matrix}\frac{min ( {W}_{sub , m i n} , {H}_{sub , m i n} )}{2} \geq \frac{{V}_{H}}{Fps} \cdot {Fr}_{span} & ( 15 ) \\ the size of a sub image = {W}_{sub} \cdot {H}_{sub} & ( 16 )\end{matrix}$$

To obtain the number of total N_{sub} images in a frame, the floor of W over W_{sub} and the floor of H over H_{sub} are needed. By multiplying them, the N_{sub} is known.

$$\begin{matrix}{N}_{sub} = ⌊ \frac{W}{{W}_{sub}} ⌋ \cdot ⌊ \frac{H}{{H}_{sub}} ⌋ & ( 17 ) \\ {N}_{data} = {N}_{sub} \cdot {N}_{sub \text{-} data} \cdot {N}_{t} & ( 18 )\end{matrix}$$

The calculation of Fr_{section} counts the numbers of frames with a time span in a time section and plus 1 for the first frame. The numerical symbol “%” in equation (19) means mod operation.

$$\begin{matrix}{Fr}_{section} = ⌊ [ \frac{Fr - ( Fr \% {N}_{t} )}{{N}_{t}} - 1 ] / {Fr}_{span} ⌋ + 1 & ( 19 ) \\ {N}_{total image} = {N}_{sub} \cdot {N}_{t} \cdot {Fr}_{section} & ( 20 )\end{matrix}$$

The calculation of Fr_{section} counts the number of frames with a time span in a time section and plus 1 for the first frame. The numerical symbol “%” in equation (19) means mod operation. N_{total image} is the total number of images in an evaluation. It determines the computation time in the preprocessing.

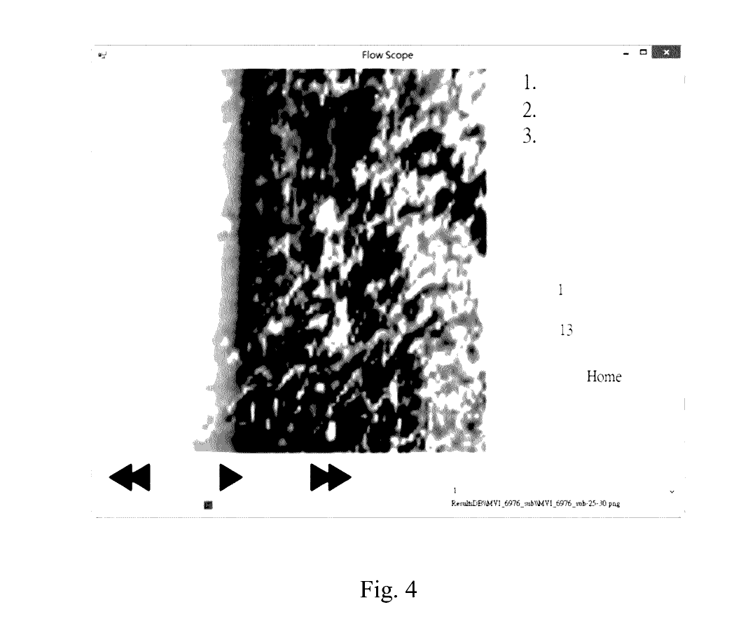

By dividing a sampled frame into multiple sub-frames and collecting multiple sub-frames situated on the same corresponding position on the each multiple sampled frames together, a sampled sub-video is formed and made accordingly as shown in FIG. 4. FIG. 4 is the interface FlowScope playing the sampled sub-video collecting multiple sub-frames situated on the same corresponding position on the each multiple sampled frames in accordance with the present invention.

Since each result the surveyor measured probably is not on the same judgment criteria, we provide three levels of confidence for each measurement result for surveyors to choose. The three levels of confidence are shown as follows:

The Good (trustable) level of confidence: the shape of the feature does not change significantly, and the surveyor surely thinks the two features on the different frames are the same one.

The Fair (mediocre) level of confidence: the shapes of the two features are slightly different, so that the surveyor recognizes them as the same one.

The Bad (uncertain) level of confidence: the shape or the motion of the features change a lot, the surveyor does not recognize them with confidence.

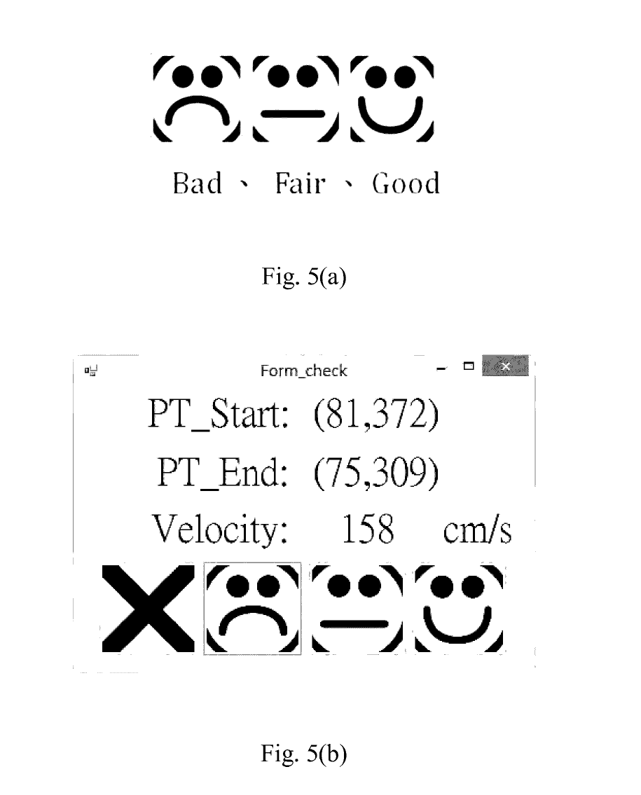

A specially designed software with a special interactive operating interface FlowScope is developed for measuring the flow velocity on the series of images, as shown in FIG. 5. The interface FlowScope includes three major modules: (1) the display module, (2) the measuring module, and (3) the evaluating module. In first part, surveyors can display the video by clicking the playing button and see the video on the viewing area by operating the display module. If they click the forward and backward button, the viewing area would show the adjacent frame on the viewing area. After finding out the region of interest, surveyors can directly click the region for detail observation. In the second part, after finding out the feature, surveyors can click the feature to mark it and click the same feature in neighboring image. The red line shows the path of the feature. In the last part, surveyors need to express their confidence on each measurement. In addition, if the measurement is false they can click the cancel button for another measurement.

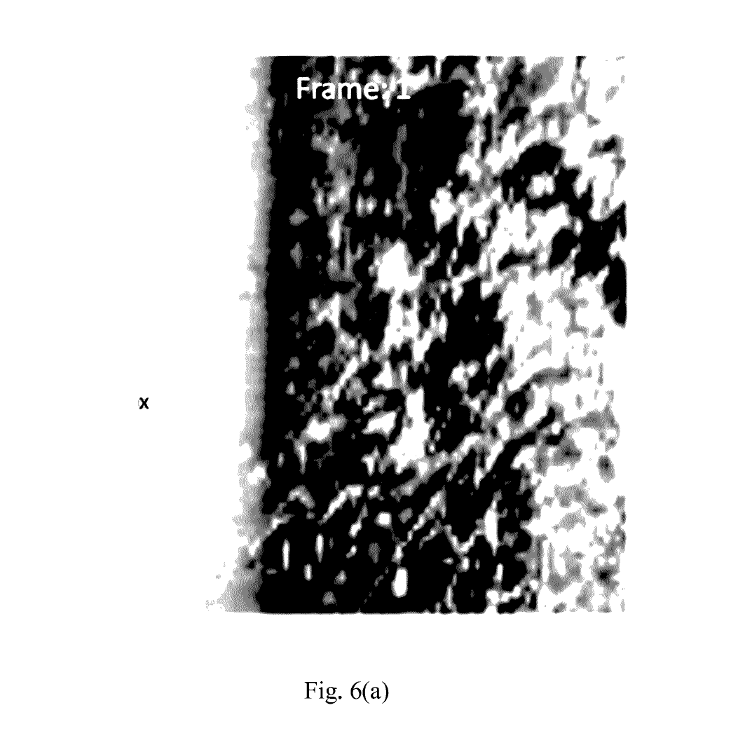

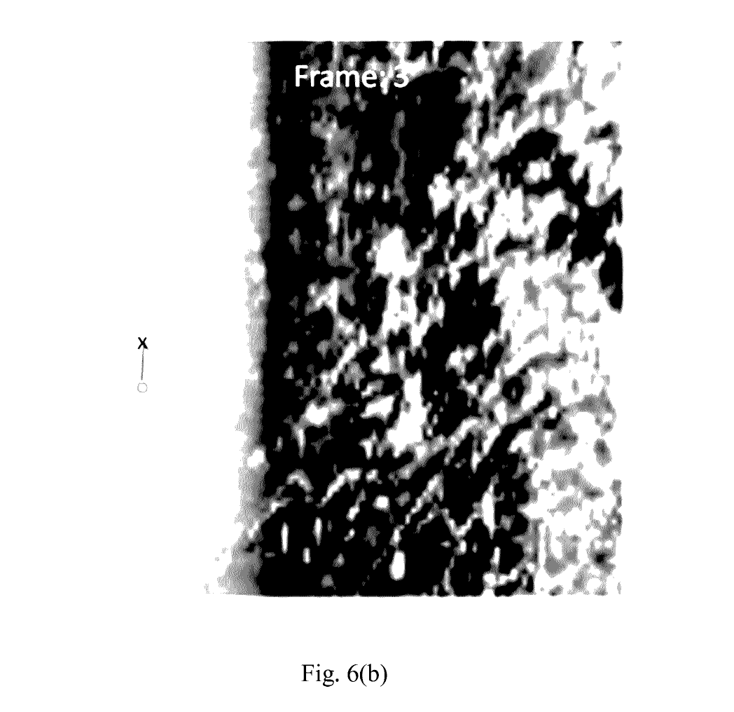

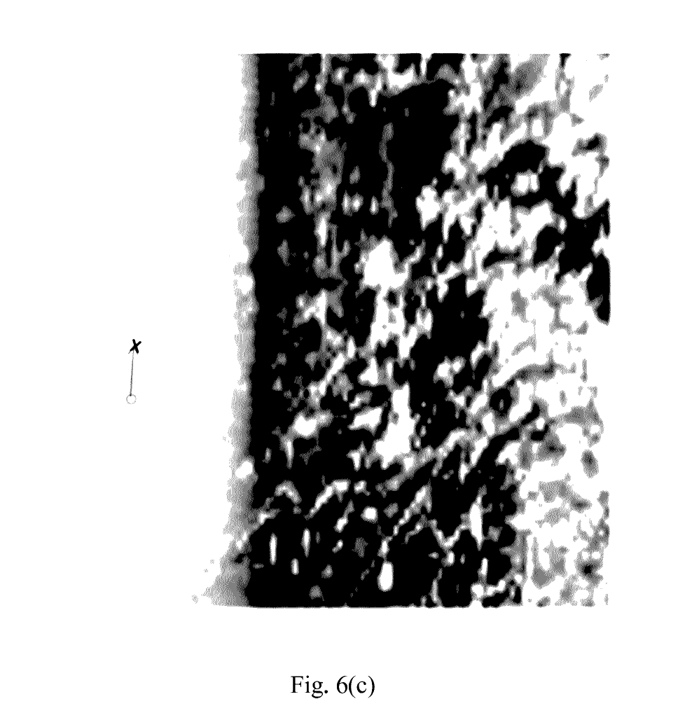

The measuring module includes two parts: the distance and the time interval. The distance measurement is to directly calculate the distance in pixels between two reference points on the image. The time interval is the traveling time of the features which is found by the surveyor. The sequential images are the frames of a video, and the sampling rate of the video determines the time interval between two frames. For example, the sampling rate of a video is 60 frames per second, and we get one over sixty seconds of the interval between two adjacent frames. The process to identify and mark the flow features including the flow direction, the flow position and the flow velocity by operating the measuring module in the interface FlowScope as shown in FIG. 6(a) through FIG. 6(c).

The distance number divided by the time interval equals to the velocity. The following is the equation of the velocity measurement.

$$Velocity = \frac{\sqrt{{( {X}_{E} - {X}_{S} )}^{2} + {( {Y}_{E} - {Y}_{S} )}^{2}}}{( {N}_{E} - {N}_{S} ) \times \frac{1}{fps}} \qquad ( 21 )$$

Where the terms X_{S}, Y_{S} denote the start point position, the terms X_{E}, Y_{E} denote the end point position, the term N_{S} denotes the number of the start frame, the term N_{E} denotes the number of the end frame, and fps denotes the sampling rate of the video.

After gathering all data in different confidence from surveyors, we develop a evaluating module to calculate the flow velocity. The level of confidence classifies the data into three groups: good, fair, and bad.

It is assumed the mode M is a simple acquired from each groups. For example, the symbol Mg is the mode of the data in good confidence, the symbol Mf is the mode of the data in fair confidence, and the symbol Mb is the mode of the data in bad confidence. The symbol N is the number of the data. For example, the symbol Ng is the total number of the data in good confidence, the symbol Nf is the total number of the data in fair confidence, and the symbol Nb is the total number of the data in bad confidence. The symbol a is the correctness ratio of samples in good confidence. The symbol fl is the correctness ratio of samples in fair confidence. The symbol y is the correctness ratio of samples in bad confidence. We can multiply the correctness ratio by the size of the data N to obtain a modified size of data N′. We use N′ as the weighting of the mode M, and calculate the weighting average to access the flow velocity.

$$\begin{matrix}{N}_{g}^{′} = α {N}_{g} & ( 22 ) \\ {N}_{f}^{′} = β {N}_{f} & ( 23 ) \\ {N}_{b}^{′} = γ {N}_{b} & ( 24 ) \\ Velocity = \frac{{N}_{g}^{′} {M}_{g} + {N}_{f}^{′} {M}_{f} + {N}_{b}^{′} {M}_{b}}{{N}_{g}^{′} + {N}_{f}^{′} + {N}_{b}^{′}} & ( 25 ) \\ Velocity = \frac{α {N}_{g} {M}_{g} + β {N}_{f} {M}_{f} + γ {N}_{b} {M}_{b}}{α {N}_{g} + β {N}_{f} + γ {N}_{b}} & ( 26 )\end{matrix}$$

### Second Embodiment

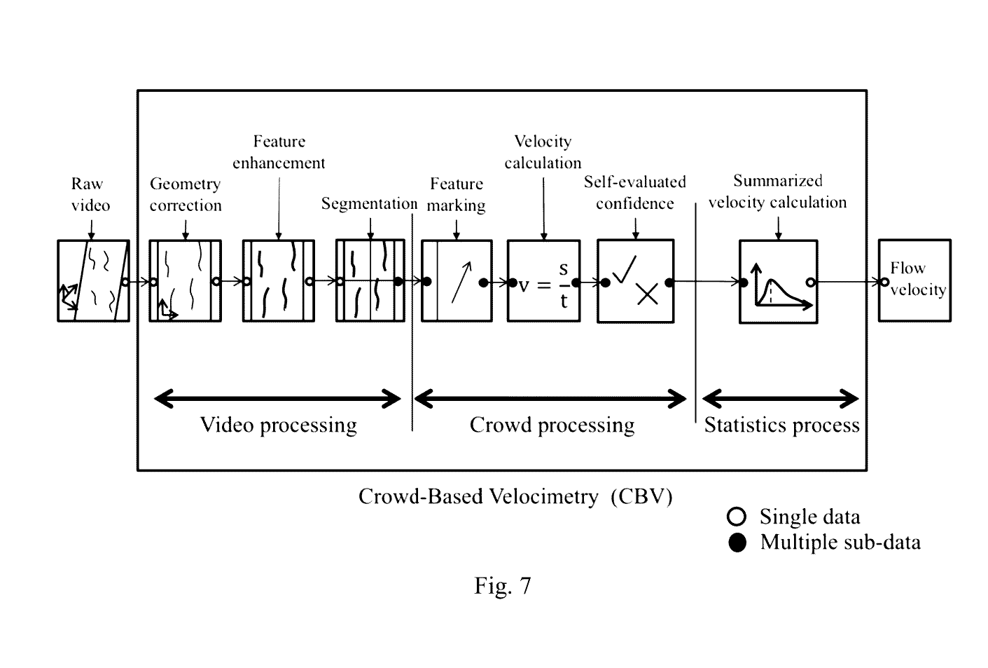

To incorporate the human perception capacity in the estimation of flow velocity, we developed a new method called crowd-based velocimetry and the calculation process for the crowd-based velocimetry as shown in FIG. 7. The crowd-based velocimetry involves in three major steps. (1) Video processing: A raw flow video, which is single data in FIG. 7, is processed using a geometrical correction method, an image enhancement method, and a segmentation method that we developed. Specific sequential sub-images of the flow are generated as multiple sub-data. A part of multiple sub-data will be distributed to an individual of a crowd. (2) Crowd processing: FlowScope, the user interface that we developed, allows a crowd to specify similar features in subsequent frames of the generated sub-images. It also allows the crowd to express their confidence when identifying the features. (3) Statistical processing: The velocity of features on an image is calculated using a velocity equation. After compiling the feature velocity data with different confidence levels obtained from the crowd, a mode of confidence weighting function is developed to calculate the flow velocity as an output single data.

To measure the on-site distance between two objects in a generated image, the images are transformed using direct linear transformation (DLT), which is a common geometrical correction method. At least six ground reference points (GRPs) are needed to determine eleven coefficients in the general DLT equation for a 3D description. In addition, the corresponding points of the GRPs on the image should be located. However, the dimensions of the DLT equation can be reduced from 3D to 2D since the water elevation does not change during video acquisition, indicating that the z-dimension can be neglected. As a result, the minimum number of GRPs required is four and the number of the coefficients is reduced to eight (C₁-C₈). The following are the modified equations:

$$\begin{matrix}u = \frac{{C}_{1} x + {C}_{2} y + {C}_{3}}{{C}_{7} x + {C}_{8} y + 1} & ( 27 ) \\ v = \frac{{C}_{4} x + {C}_{5} y + {C}_{6}}{{C}_{7} x + {C}_{8} y + 1} & ( 28 )\end{matrix}$$

To observe subtle changes in a video, we can separately apply a spatial enhancement and a temporal enhancement process on the video. We use a Canny edge detector for spatial enhancement, which shows edges including ripples or natural bubbles on the water surface in an image. It is a well-known edge detection algorithm for identifying significant edges in an image and generating binary images with the identified edges. For temporal enhancement, we use Eulerian video magnification (EVM), which amplifies the displacement of the waves, which can appear as color changes or positional changes in a video. It also amplifies the displacement of a feature vibrating with a specific frequency. The EVM was constructed by using a spatial filter and a temporal filter. The spatial filter uses λ_{c} as a frequency cut-off to magnify the motions whose image structure spatial wavelength is greater than λ_{c}. The temporal filter is a bandpass filter selecting frequencies within the range between r₁ and r₂ to be amplified. Amplification factor, α, and chromatic attenuation, chromAtt, are used to amplify motions and attenuate colors respectively.

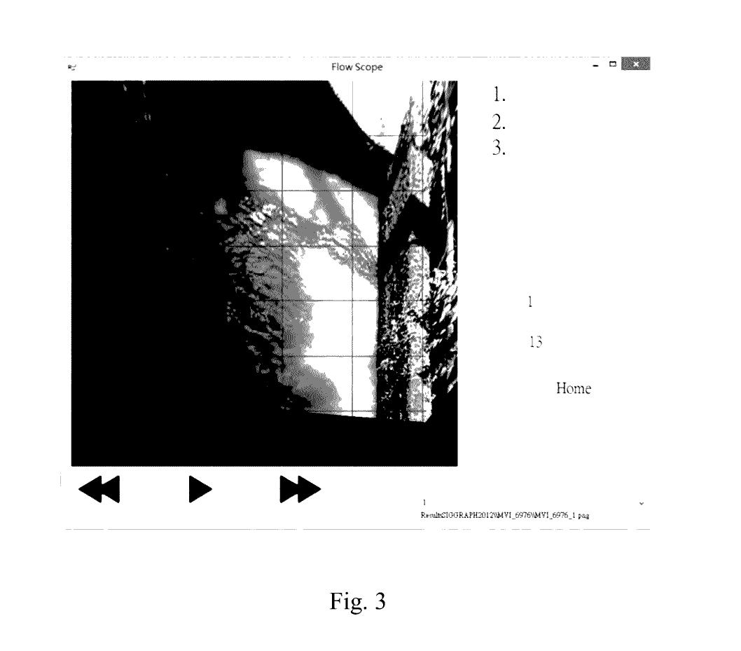

Since large video data is highly complex for a crowd-based measurement, we need to segment the video clips into small still images on both spatial and temporal domains. Under the constraints of crowd population and time consumption in CBV, we also need to estimate the expected number of data we plan to retrieve from the crowd processing step. Consequently, we developed a segmentation method called multiple intersecting parallels segmentation (MIPS). MIPS is also developed to help researchers determine an appropriate temporal size and an appropriate spatial size of an image-set for every individual of a crowd in CBV, as shown in FIG. 3. The appropriate temporal size and the appropriate spatial size are named time section and sub-image respectively herein. The MIPS is an evaluation method to slice the flow video after geometrical correction into many size-evaluated sub-images by following a parameter setup summarized as follows.

The parameters are classified into three categories as follows.

(1) Control parameters determined by the on-site environment or the setting of the camera: Vmax, fs, W, and H, where Vmax is the maximum predicted velocity of the surface flow, fs is the sampling rate of the video, and W and H are the width and height of the image after geometrical correction.

(2) Independent parameters are determined by researcher. They are w, h, D, S, nₜ, n_{data}, and τ, where w and h are the width and height of the sub-images, D is the total number of frames of the sampling video, S is the number of time sections in the video, nₜ is the number of observations required in the time section, n_{data} is the total number of measurement data obtained in an observation of a time section, and refers to the transformation ratio from the ground coordinate to the image coordinate.

(3) Dependent parameters are results of the evaluation and the input parameters of the image generation: wₘᵢₙ, hₘᵢₙ, nₛ, d, and N_{data}, where wₘᵢₙ and hₘᵢₙ are the minimum width and height of sub-images, nₛ is the number of sub-images in a frame, d is the number of selected frames in one time section, and N_{data} is the total number of data obtained in a video.

Here, we present the calculations of the parameters in MIPS. The equation (29) determines the minimum size of a sub-image, which depends on the highest velocity of the flow for which the feature of the flow can be recognized in the subsequent frames. The denominator 2 in equation (29) indicates that the maximum displacement of the feature between two subsequent frames is half of the minimum length of the sub-image.

$$\frac{min ( {w}_{m i n} , {h}_{m i n} )}{2} \geq \frac{V max}{{f}_{s}} \cdot τ \qquad ( 29 )$$

To evaluate the total number of sub-images in a frame, nₛ, is obtained from the product of the floor of W over w and the floor of H over h, as given in equation (30). N_{data} is obtained by multiplying nₜ, N_{data}, and S.

$$\begin{matrix}{n}_{s} = ⌊ \frac{W}{w} ⌋ \cdot ⌊ \frac{H}{h} ⌋ & ( 30 ) \\ {N}_{data} = S \cdot {n}_{t} \cdot {n}_{data} & ( 31 ) \\ d = \frac{D}{S} & ( 32 )\end{matrix}$$

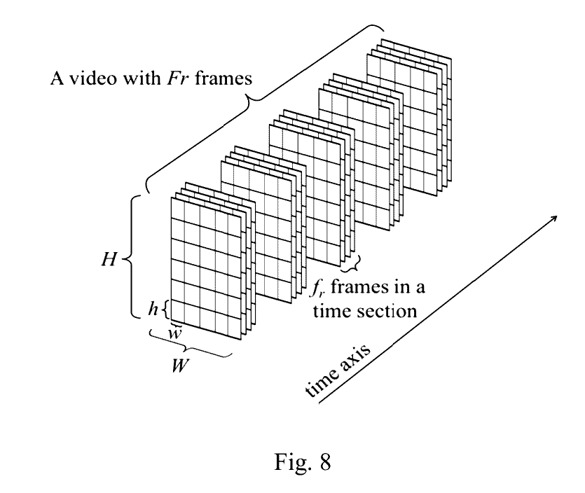

Next, d is calculated by counting the number of frames within a time section. FIG. 8 shows a sample case which MIPS was applied in, where S=5, D=20 and d=4.

To facilitate feature marking by a crowd, we have developed FlowScope, a user interface for measuring the flow velocity from a series of images. The interface FlowScope is developed by using computer language C#, which is a programming language for interface development. The interface FlowScope consists of three main components: (1) feature marking, (2) velocity calculations, and (3) self-evaluated confidence.

Observers are allowed to mark any feature which is recognized as a flow velocity-relevant feature by them on a flow video (e.g. floating small objects, natural surface bubbles, and surface ripples). During the feature marking process, the observers can display the video by clicking the play button to watch the video on the display area. The forward and backward buttons show the subsequent frames in the viewing area. After selecting the region of interest, the observer can directly click the region for detailed observations, click the feature to mark it, and then click the same feature in subsequent frames. Finally, the interface FlowScope will show the path of the marked feature.

The flow velocity magnitude, V, is given by the ratio of the distance number (the distance in pixels between two reference points) to the time interval (the travelling time of two features in subsequent frames recognized as the same feature), as shown below.

$$V = \frac{\sqrt{{( {X}_{E} - {X}_{S} )}^{2} + {( {Y}_{E} - {Y}_{S} )}^{2}}}{( {N}_{E} - {N}_{S} ) / {f}_{s}} \qquad ( 33 )$$

Here X_{S}, Y_{S} denote the start-point position, X_{E}, Y_{E} denote the end-point position, N_{S} denotes the number of the start frame, and N_{E} denotes the number of the end frame.

Observers need to express their confidence on each measurement by choosing one of the three confidence levels. (1) Good (trustable level): the shape of the feature does not change significantly, and the observer is sure that the two features on the subsequent frames are the same one. (2) Neutral (mediocre level): the shapes of the two features are only slightly different and so the observer recognizes them as the same. (3) Poor (uncertain level): the shape or the motion of the feature changes considerably, and the observer recognizes the features on the different frames to be different with confidence.

We developed a function to calculate the flow velocity, V_{cbv}, after gathering data with different confidence levels from the observers, see equation (34). According to the level of confidence, the data are classified into good, neutral, and poor. The modes of probability distribution function (PDF) of data with good, neutral, and poor confidence levels are Mg, Mn, and Mp, respectively. In addition, we used the weighting factors of the modes of data with different confidence levels in the function to express the reliability of data. kg, kn, and kp are weighting factors of data with good, neutral, and poor confidence levels, respectively. Weighting factors describe the importance of the three confidences evaluated by a crowd.

$${V}_{cbv} = \frac{kgMg + knMn + kpMp}{kg + kn + kp} \qquad ( 34 )$$

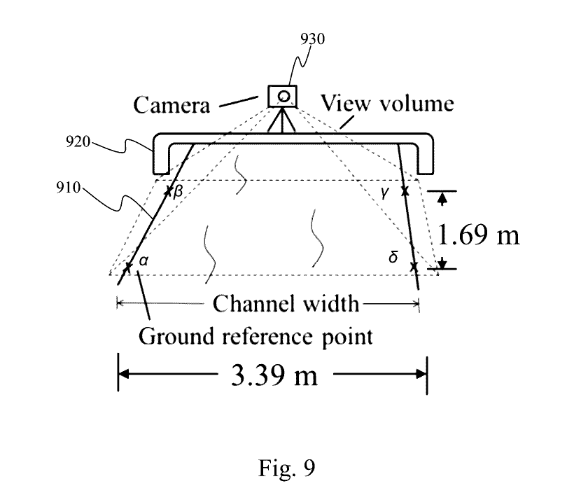

FIG. 9 is a schematic diagram illustrating the on-site field configuration for the flow velocity measuring method based on multiple observations in accordance with the present invention. For the implementation, in order to film a video recording the flow flowing in a man-made channel 910, a solid beam support 920 used for carrying the camera 930 to make the video is built across the man-made channel 910. The on-site camera configuration is as shown in FIG. 9.

The field description and the ground reference points (GRPs) settings are disclosed as follows. The man-made channel 910 has a width about 3.39 m. Four suitable GRPs α, β, γ and δ were selected to obtain the dimensions of the images. The GRPs α, β, γ and δ could be easily found on the images in FIG. 9 and were able to be positioned on the site. After ensuring that all GRPs α, β, γ and δ were inside the view of sight of the camera 930, the digital single-lens reflex (DSLR) camera is started to film video at a frame rate of 60 frames per second with a resolution of 1280×720 pixels, covering a 5.6 square meter area of the channel 910. We recorded the video for 3 seconds for the implementation and then applied the above-mentioned DLT correction and EVM enhancement methods to generate the three videos (as shown in FIG. 2(a) through FIG. 2(c)). Each one pixel in the three videos represents 0.01 m on site.

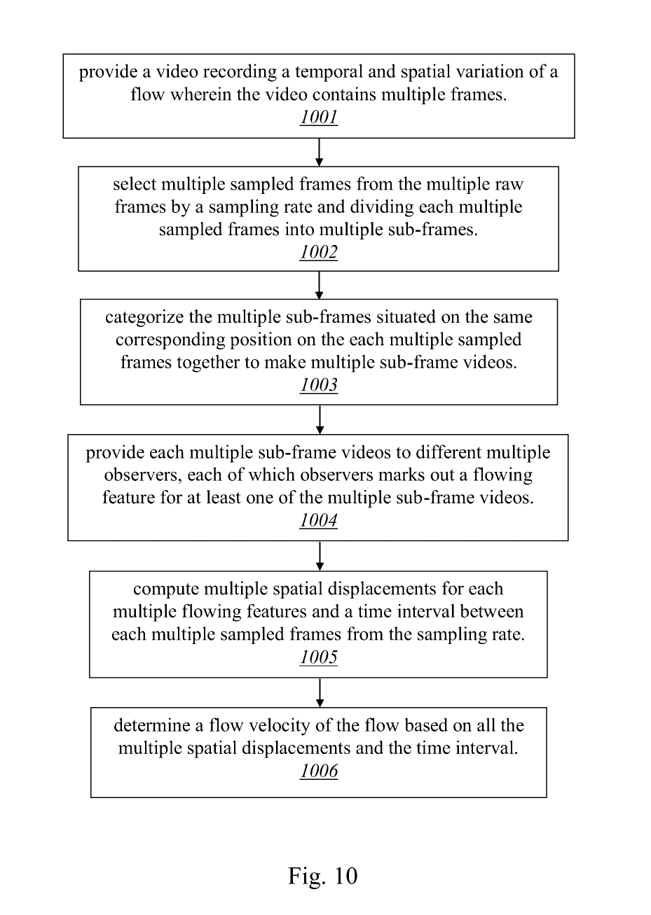

Accordingly, it is easily to conclude the following required steps for performing the above flow velocity measuring method as correspondingly shown in FIG. 10. Step 1001: provide a video recording a temporal and spatial variation of a flow wherein the video contains multiple frames. Step 1002: select multiple sampled frames from the multiple raw frames by a sampling rate and dividing each multiple sampled frames into multiple sub-frames. Step 1003: categorize the multiple sub-frames situated on the same corresponding position on the each multiple sampled frames together to make multiple sub-frame videos. Step 1004: provide each multiple sub-frame videos to different multiple observers, each of which observers marks out a flowing feature for at least one of the multiple sub-frame videos. Step 1005: compute multiple spatial displacements for each multiple flowing features and a time interval between each multiple sampled frames from the sampling rate. Step 1006: determine a flow velocity of the flow based on all the multiple spatial displacements and the time interval.

There are further embodiments provided as follows.

Embodiment 1: A flow velocity measuring method includes: providing a video recording a temporal and spatial variation of a flow wherein the video contains multiple frames; selecting multiple sampled frames from the multiple raw frames by a sampling rate and dividing each multiple sampled frames into multiple sub-frames; grouping the multiple sub-frames situated on the same corresponding position on the each multiple sampled frames together to make multiple sub-frame videos; providing each multiple sub-frame videos to different multiple observers, each of which observers marks out a flowing feature for at least one of the multiple sub-frame videos; computing multiple spatial displacements for each multiple flowing features and a time interval between each multiple sampled frames from the sampling rate; and determining a flow velocity of the flow based on all the multiple spatial displacements and the time interval.

Embodiment 2: The flow velocity measuring method according to Embodiment 1, the video consists of a series of the multiple raw frames filmed according to a frame rate, the multiple raw frames are continuous in temporary and the video records the temporal and spatial variation of the flow by the multiple raw frames.

Embodiment 3: The flow velocity measuring method according to Embodiment 1, further includes one of the following steps: determining the sampling rate so as to select the multiple sampled frames from the multiple raw frames; and determining the time interval between each multiple sampled frames based on the sampling rate.

Embodiment 4: The flow velocity measuring method according to Embodiment 1, further includes: determining the sampling rate so as to select at least two sampled frames from the multiple raw frames.

Embodiment 5: The flow velocity measuring method according to Embodiment 1, further includes one of the following steps: performing a geometric correction to at least one of the multiple sampled frames so as to obtain a corrected dimension therefor; and implementing a direct linear transform to perform the geometric correction.

Embodiment 6: The flow velocity measuring method according to Embodiment 5, further includes one of the following steps: performing an image enhancement to the multiple corrected sampled frames so as to enhance the multiple flowing features contained in each multiple corrected sampled frames; and implementing an Euler image magnification to perform the image enhancement.

Embodiment 7: The flow velocity measuring method according to Embodiment 1, further includes: dividing each multiple sampled frames into multiple sub-frames by a multiple-intersecting parallels dividing scheme.

Embodiment 8: The flow velocity measuring method according to Embodiment 1, further includes one of the following steps: evaluating a confidence level for whether the multiple flowing features on different multiple sub-frames belong to the same flowing behavior based on a degree of variation for the multiple flowing features; weighting each multiple flowing features based on the evaluated confidence level; and computing multiple weighted spatial displacements for each multiple weighted flowing features and determining a flow velocity of the flow based on the multiple weighted spatial displacements.

Embodiment 9: The flow velocity measuring method according to Embodiment 8, the confidence level includes the trustable level, the mediocre level and the uncertain level.

Embodiment 10: The flow velocity measuring method according to Embodiments 1, 2, 3 or 8, further includes one of the following steps: providing a displaying interface for displaying the video and the multiple sub-frame videos for the observers, wherein the displaying interface is designed to show the observers the guiding instructions for selecting the multiple sampled frames from the multiple raw frames and for determining the frame rate and the sampling rate; providing a measuring interface for the observers to operate to mark out multiple flowing features on each multiple sub-frames; and providing an evaluating interface for the observers to operate to evaluate the confidence level.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

1. (canceled)

2. (canceled)

3. A flow velocity measuring method comprising:
providing a video recording a temporal and spatial variation of a flow wherein the video contains multiple frames;
selecting multiple sampled frames from the multiple raw frames by a sampling rate and dividing each multiple sampled frames into multiple sub-frames;
grouping the multiple sub-frames situated on the same corresponding position on the each multiple sampled frames together to make multiple sub-frame videos;
providing each multiple sub-frame videos to different multiple observers, each of which observers marks out a flowing feature for at least one of the multiple sub-frame videos;
computing multiple spatial displacements for each multiple flowing features and a time interval between each multiple sampled frames from the sampling rate; and
determining a flow velocity of the flow based on all the multiple spatial displacements and the time interval.

4. The flow velocity measuring method as claimed in claim 3, wherein the video consists of a series of the multiple raw frames filmed according to a frame rate, the multiple raw frames are continuous in temporary and the video records the temporal and spatial variation of the flow by the multiple raw frames.

5. The flow velocity measuring method as claimed in claim 3, further comprising one of the following steps:
determining the sampling rate so as to select the multiple sampled frames from the multiple raw frames; and
determining the time interval between each multiple sampled frames based on the sampling rate.

6. The flow velocity measuring method as claimed in claim 3, further comprising: determining the sampling rate so as to select at least two sampled frames from the multiple raw frames.

7. The flow velocity measuring method as claimed in claim 3, further comprising one of the following steps:
performing a geometric correction to at least one of the multiple sampled frames so as to obtain a corrected dimension therefor; and
implementing a direct linear transform to perform the geometric correction.

8. The flow velocity measuring method as claimed in claim 7, further comprising one of the following steps:
performing an image enhancement to the multiple corrected sampled frames so as to enhance the multiple flowing features contained in each multiple corrected sampled frames; and
implementing an Euler image magnification to perform the image enhancement.

9. The flow velocity measuring method as claimed in claim 3, further comprising:
dividing each multiple sampled frames into multiple sub-frames by a multiple-intersecting parallels dividing scheme.

10. The flow velocity measuring method as claimed in claim 3, further comprising one of the following steps:
evaluating a confidence level for whether the multiple flowing features on different multiple sub-frames belong to the same flowing behavior based on a degree of variation for the multiple flowing features;
weighting each multiple flowing features based on the evaluated confidence level; and
computing multiple weighted spatial displacements for each multiple weighted flowing features and determining a flow velocity of the flow based on the multiple weighted spatial displacements.

11. The flow velocity measuring method as claimed in claim 8, wherein the confidence level includes the trustable level, the mediocre level and the uncertain level.

12. The flow velocity measuring method as claimed in claim 3, further comprising one of the following steps:
providing a displaying interface for displaying the video and the multiple sub-frame videos for the observers, wherein the displaying interface is designed to show the observers the guiding instructions for selecting the multiple sampled frames from the multiple raw frames and for determining the frame rate and the sampling rate;
providing a measuring interface for the observers to operate to mark out multiple flowing features on each multiple sub-frames; and
providing an evaluating interface for the observers to operate to evaluate the confidence level.

13. The flow velocity measuring method as claimed in claims 4, further comprising one of the following steps:
providing a displaying interface for displaying the video and the multiple sub-frame videos for the observers, wherein the displaying interface is designed to show the observers the guiding instructions for selecting the multiple sampled frames from the multiple raw frames and for determining the frame rate and the sampling rate;
providing a measuring interface for the observers to operate to mark out multiple flowing features on each multiple sub-frames; and
providing an evaluating interface for the observers to operate to evaluate the confidence level.

14. The flow velocity measuring method as claimed in claims 5, further comprising one of the following steps:
providing a displaying interface for displaying the video and the multiple sub-frame videos for the observers, wherein the displaying interface is designed to show the observers the guiding instructions for selecting the multiple sampled frames from the multiple raw frames and for determining the frame rate and the sampling rate;
providing a measuring interface for the observers to operate to mark out multiple flowing features on each multiple sub-frames; and
providing an evaluating interface for the observers to operate to evaluate the confidence level.

15. The flow velocity measuring method as claimed in claims 10, further comprising one of the following steps:
providing a displaying interface for displaying the video and the multiple sub-frame videos for the observers, wherein the displaying interface is designed to show the observers the guiding instructions for selecting the multiple sampled frames from the multiple raw frames and for determining the frame rate and the sampling rate;
providing a measuring interface for the observers to operate to mark out multiple flowing features on each multiple sub-frames; and
providing an evaluating interface for the observers to operate to evaluate the confidence level.
